(19) United States
(12) Patent Application Publication
(10) Pub. No.: US 2011/0076658 A1
(43) Pub. Date: Mar. 31, 2011

(54) EYE PATCH KIT AND METHODS OF PROMOTING USE COMPLIANCE

(75) Inventors: Christine Jerome, San Diego, CA (US); Victor Jerome, San Diego, CA (US)

(73) Assignee: SAVCO OPTICAL, INC., San Diego, CA (US)

(21) Appl. No.: 12/570,460

(22) Filed: Sep. 30, 2009

(51) Int. Cl. G09B 19/00; B65D 71/00

(52) U.S. Cl. 434/262; 206/570

(57) ABSTRACT

A kit and method for promoting eye patch wear compliance for an afflicted child with a condition requiring wearing an eye patch are provided herein, including an eye patch kit for promoting patch wear compliance for an afflicted child with a condition requiring wearing an eye patch, comprising: a carrying case; at least one eye patch with a front surface and an adhesive back surface that is disposed to be worn over one eye, the eye patch comprising a stretchable and breathable material, and a black-out layer for total occlusion for shielding of light; a plurality of self adhesive stickers disposed to be attached to and decorate the eye patch on the front surface; and an instruction guide having explanation for decorating the eye patch.

### FIELD OF INVENTION

The present invention generally relates to eye patches, and particularly to a decorative eye patch for children and method of promoting use compliance.

### BACKGROUND OF THE INVENTION

Amblyopia or ambyopia, which is also referred to as lazy eye occurs when the brain and eyes do not work together properly. In children with Amblyopia, the brain favors one eye. The cause has been linked to the lack of use of the afflicted eye in early childhood. One treatment for this condition involves correcting the optical deficit by forcing use of the amblyopic eye by patching the good eye. One significant problem with respect to wearing a patch for treatment of amblyopia is compliance with wearing the eye patch, especially in children. The major factor includes social reasons because children are more likely to be embarrassed about having to wear the eye patch to school or in any social setting.

While there has been a trend to provide more user-friendly patches that are less conspicuous, further improvements in promoting patch wear compliance are desirable. As can be seen, there is a need for a more effective patch that promotes wear compliance.

### SUMMARY OF THE INVENTION

One aspect of the present invention includes an eye patch kit for promoting eye patch wear compliance for an afflicted child with a condition requiring wearing an eye patch, comprising: a carrying case; at least one eye patch with a front surface and an adhesive back surface that is disposed to be worn over one eye, the eye patch comprising a stretchable and breathable material, and a black-out layer for total occlusion for shielding of light; a plurality of self adhesive stickers disposed to be attached to and decorate the eye patch on the front surface; and an instruction guide having explanation for decorating the eye patch.

Another aspect of the present invention includes a method to promote compliance for wearing an eye patch by a child afflicted with a condition requiring wearing the eye patch, comprising: providing one or more eye patch kits comprising: a carrying case; at least one eye patch with a front surface and an adhesive back surface that is disposed to be worn over one eye, the eye patch comprising a stretchable and breathable material, and a black-out layer for total occlusion for shielding of light; a plurality of self adhesive stickers disposed to be attached to and decorate the eye patch on the front surface; an instruction guide having explanation for decorating the eye patch; and coaching a plurality of children as to why the afflicted child must wear the eye patch, and to support the plurality of children such that each of the children can pick out and decorate a patch for the afflicted child, making the process of making the eye patch a group activity and promoting enhanced compliance for the afflicted child to wear the eye patch.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views.

FIG. 1 shows a perspective view of the contents of an exemplary kit according an embodiment the present invention.

FIG. 2A shows front view of an afflicted child wearing an exemplary eye patch according to the present invention; FIG. 2B shows a front view of an exemplary eye patch according to the present invention.

FIG. 3 shows a perspective view of an exemplary container and contents according to the present invention.

FIG. 4 shows a perspective view of an exemplary educational setting with an instructor and a plurality of children.

FIG. 5 shows an exploded view of an exemplary eye patch according to the present invention.

### DETAILED DESCRIPTION OF THE INVENTION

Further objectives and advantages of the present invention will become apparent as the description proceeds and when taken in conjunction with the accompanying drawings. To gain a full appreciation of the scope of the present invention, it will be further recognized that various aspects of the present invention can be combined to make desirable embodiments of the invention. Unless defined otherwise, all technical and scientific terms used herein have the same meaning as commonly understood by one of ordinary skill in the art to which this invention belongs. Where a term is provided in the singular, the inventor also contemplates the plural of that term. The nomenclature used herein and the procedures described below are those well known and commonly employed in the art.

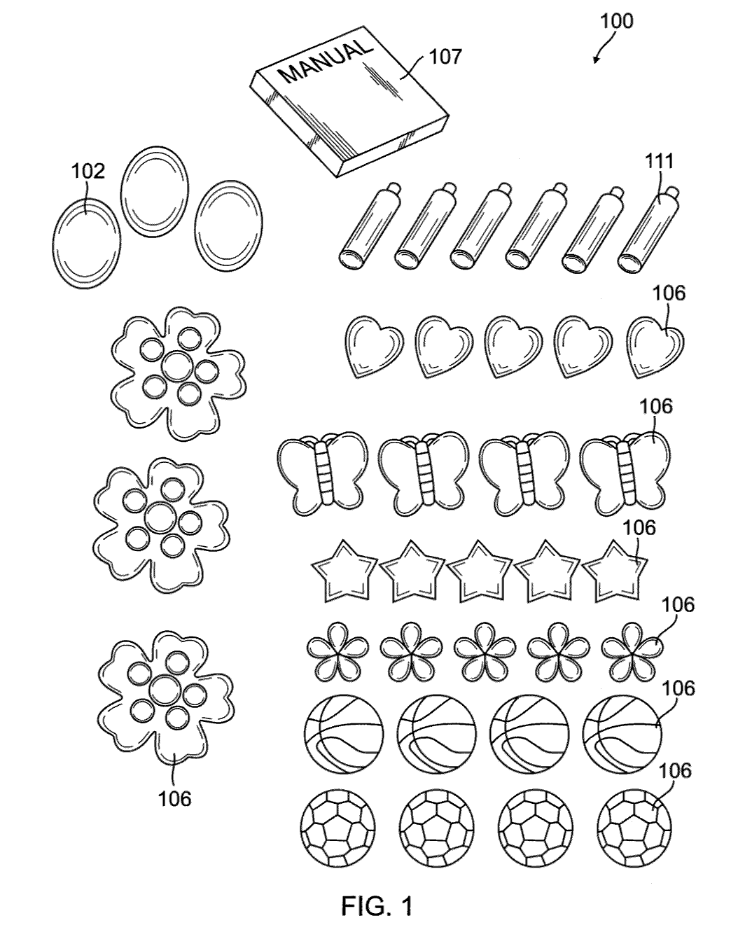

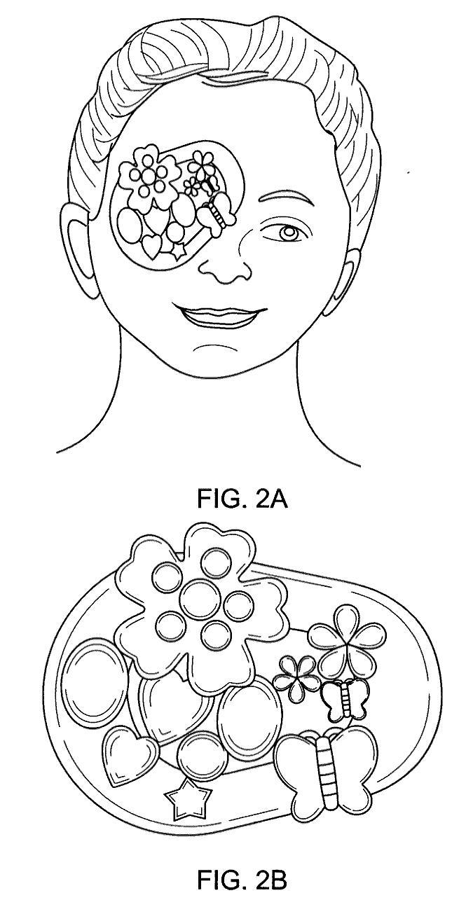

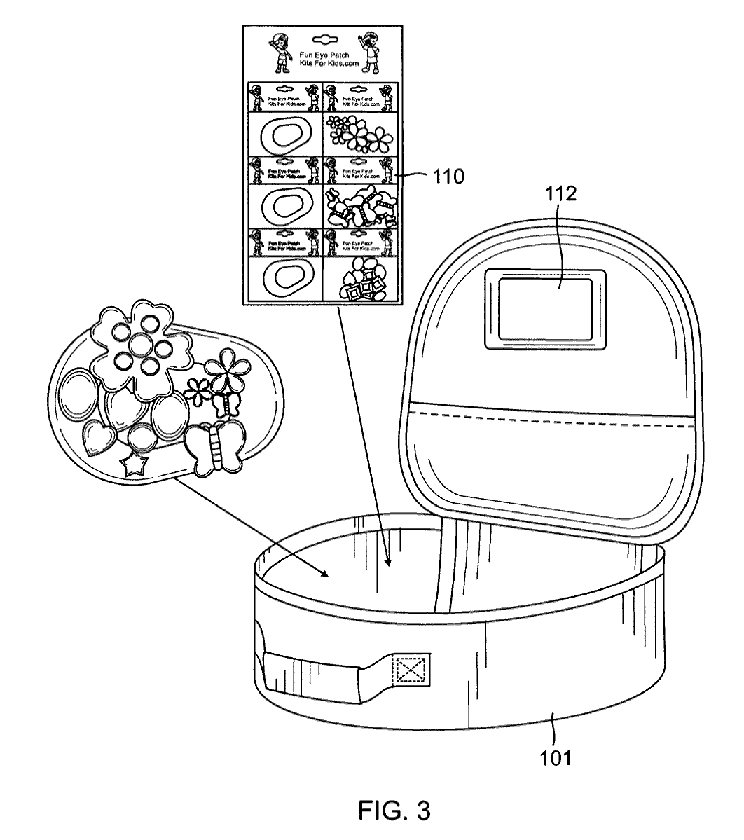

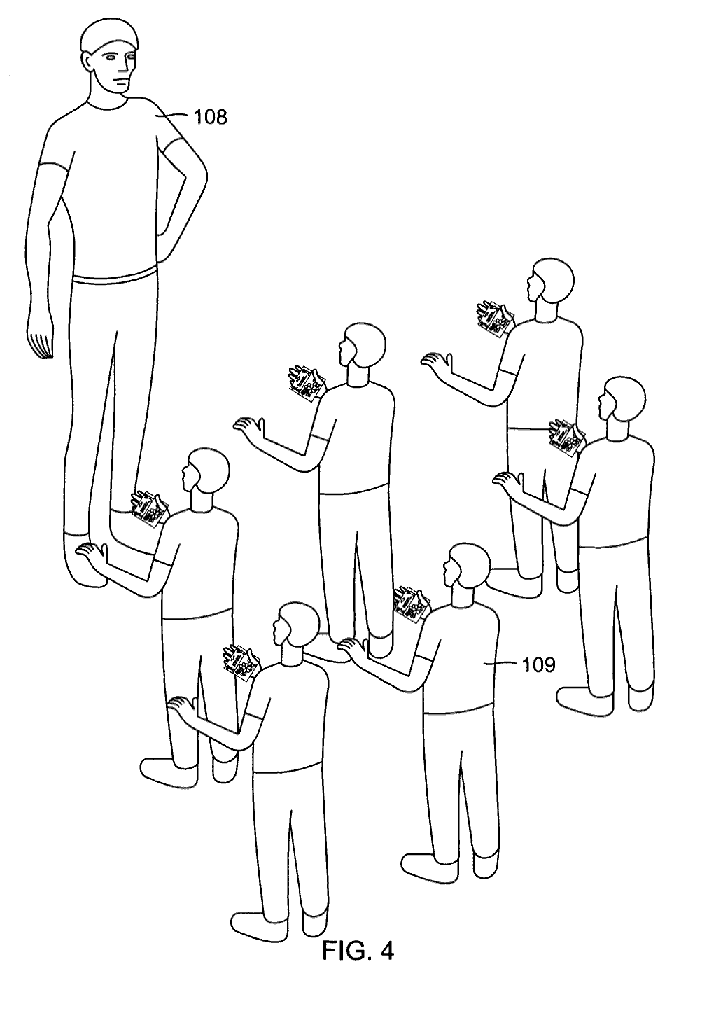

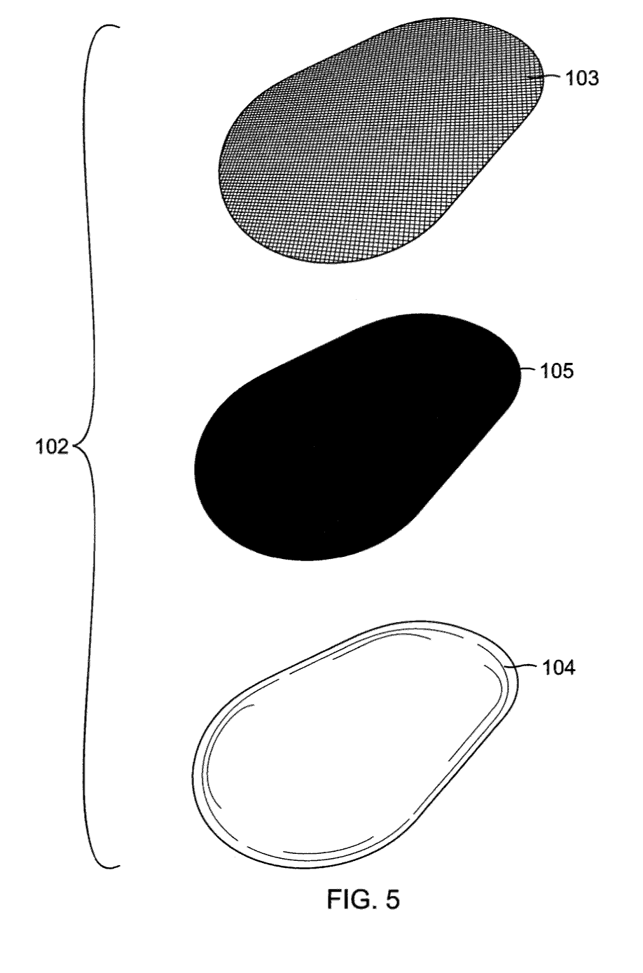

Referring to FIGS. 1 through 5, one embodiment of the present invention includes an eye patch kit 100 for promoting patch wear compliance for an afflicted child with a condition requiring wearing an eye patch 102, such as amblyopia (lazy eye), strabismus, cataracts, lens implants, and other childhood eye aliments that require a child to patch the strong eye in order to make the weak eye strong. The kit 100 of the present invention may include a packaging 110 and a carrying case 101, such as a custom designed carrying case 101 with colors, logos, and stickers as desired for a child who will be using the kit 100. For example, the carrying case 101 may be shaped similar to a lunch box lunch that is transformed into a type of cosmetic bag with pouches for the rainbow color patches and a mirror 112, which the afflicted child can use to look into for the proper attachment of the eye patch 102 over the eye.

An important aspect of the present invention is the eye patch 102, which may be provided in a plurality of shapes and geometries, provided in various colors, and also made in various sizes to accommodate children of different age. For example, a junior size may be provided for children up to the age of three, and a larger regular size for children above the age of four. Preferably, the eye patch 102 is an adhesive, non-toxic, latex-free, one-time use eye patch made from a hypo-allergenic, mono-woven fabric. They eye patch kit 100 can include at least one eye patch 102 with a front surface 103 and an adhesive back surface 104 that is disposed to be worn over one eye. The adhesive may be integral with the back surface 104, or be a separately applied layer of adhesive material. A covering (not shown) may be provided to the adhesive back surface 104 of the eye patch 102 which will be removed before applying the eye patch 102 to the afflicted eye. The adhesive on the back surface 104 of the eye patch should be non-toxic to avoid any possible danger to the child. The eye patch 102 may be made from a stretchable and breathable material and include a black-out layer 105 for total occlusion for shielding of light. The black-out layer 105 may be part of the back surface 104 of the eye patch 102 or may be a separate piece and sandwiched between the front surface 103 and back surfaces 104. The black-out layer 105 may be made from an opaque material, which is not transparent or translucent and impenetrable to light, meaning not allowing light to pass through. The black-out layer 105 may be a black film, plastic, rubber, or the like. The eye patch 102 as a whole and in particular the black-out layer 105 should not include any holes which will allow light to enter the wearer's eye making the wearer fixate looking at the light.

The kit of the present invention may include a plurality of self adhesive stickers 106, which are fun for children to use as decoration for the front surface 103 of the eye patch 102. These self adhesive stickers 106 may be any type of stickers that are suitable for this purpose, for example, laser printed flat or puffy stickers; acrylic stickers of various shapes such as flowers, butterflies, or hearts; foam glitter stickers; and google-eye stickers. The stickers 106 may have various themes, such as sports stickers, Christmas stickers, or other holiday themed stickers. The self adhesive glue of the stickers should be non-toxic to avoid any danger for the child.

In order to make the kit of the present invention more effective in promoting compliance with eye patch wear, the kit may include an instruction guide or manual 107. The instruction guide 107 may include description of various afflictions where the use of an eye patch is necessary. Preferably, the instruction manual 107 can include guidance for at least one adult supervisor 108 to provide coaching to a plurality of children 109 as to why the afflicted child must wear the eye patch, and to support the plurality of children 109 such that each of the children 109 can pick out and decorate a patch 102 for the afflicted child, making the process of making the eye patch 102 a group activity and promoting enhanced compliance for the afflicted child to wear the eye patch 102. The instruction manual 107 may include personal testimony of how this kit worked for others at home and school.

The eye patch kit 100 of the present invention can also include one or more non-toxic writing utensils 111, such that the plurality of children 109 making eye patches 102 for the afflicted child can write their names on the covering (not shown) that protects the adhesive back surface 104 of the eye patches 102.

With the kit and method of the present invention, the teasing that may follow a child's wearing of an eye patch can end and the compliance promoted and enhanced. Once parents can eliminate the “you must wear this” comment for wearing the eye patch, what appeared to be a negative thing, i.e., wearing a patch, can be turned into a positive and fun activity that ultimately promotes compliance. This is achieved by eliminating the plain and unsightly brown patches that can single out a child who must wear an eye patch.

The present invention may be used at home with a child, where the child picks out and decorates a new eye patch 102 each day. It can be made part of a daily routine, and may become a fun part of a child's morning routine. This can treat the afflicted eye by letting kids make their own patches 102. This makes patching the eye fun and easier, which can give some of the control of patching back to the child. This can also give the children something to be proud of while wearing the eye patch 102 rather than being embarrassed. The child can feel special by having their very own kit to make the eye patches.

The present invention can also be used at school, where a parent 108 can take the kit to school with the child and explain to the other children and fellow classmates 109 why the child needs to wear an eye patch 102; that the eye patch 102 is making the child's other eye strong. The other children and classmates 109 can each make the child an eye patch 102. It can be explained to children 109 that now they are all helping make the child's eye strong and how great they are for helping. Each child can place his/her name on the backs of their eye patches 102, and each day the child can wear a friend's eye patch 102 to school. The teacher can help in making this a guessing game of the other students to try and guess whose patch the child is wearing.

The present invention can also be used for a play date with friends, where this can be another opportunity for the child to share his/her patch kit with friends. The children can follow instructions right at home with friends, and the next time the child is going to see the friend, he/she can wear the friend's patch. Under such home setting, a parent can promote compliance at home for younger children who do not attend school.

### EXAMPLES

### Example 1

The deluxe kit for girls can include a custom kit carrying case with logo on front of the bag; 60 adhesive eye patches, 6 colors 10 of each; 3 styles of self adhesive acrylic stickers, 20 pieces each, e.g., flower, butterfly, and hearts; 1 bag foam glitter self adhesive stickers, 60 pieces; 1 bag self adhesive google eyes, 48 pieces; and 2 sheets of stickers, 1 laser and 1 puffy.

### Example 2

The deluxe kit for boys can include custom carrying case with logo on front of bag; 60 adhesive eye patches, 6 colors, 10 of each; 1 bag of sport foam self adhesive stickers, 60 pieces; 1 bag self adhesive google eyes, 48 pieces; 1 bag foam shape stickers, 60 pieces; 2 sheets of stickers, 1 laser and 1 puffy.

### Example 3

The mini kits—smaller versions of the deluxe for boys, gills and various holidays, which can include 1 month supply of patches:

The mini kit for girls can include 30 adhesive eye patches, 3 colors; 3 styles of self adhesive acrylic stickers, 20 pieces each, e.g., flower, butterfly, and hearts.

The mini kit for Christmas can include 30 adhesive eye patches, e.g., red, green, and blue; 1 bag foam Christmas adhesive stickers, 60 pieces; 1 bag acrylic Christmas tree adhesive sticker; and 1 Sheet laser Christmas sticker.

The mini kit for boys can include 30 eye patches, 3 colors; 1 bag of foam sport stickers, 60 pieces; 1 bag of google eyes, 48 pieces, and 1 laser sticker sheet.

All headings are for the convenience of the reader and should not be used to limit the meaning of the text that follows the heading, unless so specified. Various changes and departures may be made to the present invention without departing from the spirit and scope thereof. Accordingly, it is not intended that the invention be limited to that specifically described in the specification or as illustrated in the drawings, but only as set forth in the claims. Although the invention has been described and illustrated with respect to exemplary embodiments thereof, it should be understood by those skilled in the art that the foregoing and various other changes, omissions, and additions may be made therein and thereto, without parting from the spirit and scope of the present invention.

What is claimed is:

1. An eye patch kit for promoting eye patch wear compliance for an afflicted child with a condition requiring wearing an eye patch, comprising:
a carrying case;
at least one eye patch with a front surface and an adhesive back surface that is disposed to be worn over one eye, the eye patch comprising a stretchable and breathable material, and a black-out layer for total occlusion for shielding of light;
a plurality of self adhesive stickers disposed to be attached to and decorate the eye patch on the front surface; and
an instruction guide having explanation for decorating the eye patch.

2. The eye patch kit of claim 1, wherein the eye patch comprises an adhesive, non-toxic, latex-free, one-time use eye patch made from a hypo-allergenic, mono-woven fabric.

3. The eye patch kit of claim 2, wherein the front surface of the eye patch comprises one or more geometric shapes and one or more colors.

4. The eye patch kit of claim 1, wherein the plurality of self adhesive stickers are selected from a group consisting of flat stickers, puffy stickers, acrylic stickers, foam glitter stickers, and google-eye stickers.

5. The eye patch kit of claim 1, wherein the instruction guide includes instructions for at least one adult supervisor to provide coaching to a plurality of children as to why the afflicted child must wear the eye patch, and to support the plurality of children such that each of the children can pick out and decorate a patch for the afflicted child, making the process of making the eye patch a group activity and promoting enhanced compliance for the afflicted child to wear the eye patch.

6. The eye patch kit of claim 1, further comprising one or more writing utensils, such that the plurality of children making eye patches for the afflicted child can written their names on the eye patches.

7. A method to promote compliance for wearing an eye patch by a child afflicted with a condition requiring wearing the eye patch, comprising:
providing one or more eye patch kits comprising:
a carrying case;
at least one eye patch with a front surface and an adhesive back surface that is disposed to be worn over one eye, the eye patch comprising a stretchable and breathable material, and a black-out layer for total occlusion for shielding of light;
a plurality of self adhesive stickers disposed to be attached to and decorate the eye patch on the front surface;
an instruction guide having explanation for decorating the eye patch; and
coaching a plurality of children as to why the afflicted child must wear the eye patch, and to support the plurality of children such that each of the children can pick out and decorate a patch for the afflicted child, making the process of making the eye patch a group activity and promoting enhanced compliance for the afflicted child to wear the eye patch.

8. The method of claim 7, wherein the coaching is done in a classroom setting.

9. The method of claim 7, wherein the coaching is done at home with a group of friends.
